(19) United States
(12) Patent Application Publication
(10) Pub. No.: US 2022/0126371 A1
(43) Pub. Date: Apr. 28, 2022

(54) METHOD FOR HIGH TEMPERATURE HEAT TREATING OF METAL OBJECTS FORMED IN A METAL DROP EJECTING THREE-DIMENSIONAL (3D) OBJECT PRINTER

(71) Applicant: Xerox Corporation, Norwalk, CT (US)

(72) Inventor: Chu-Heng Liu, Penfield, NY (US)

(21) Appl. No.: 17/451,501

(22) Filed: Oct. 20, 2021

Related U.S. Application Data
(60) Provisional application No. 63/104,547, filed on Oct. 23, 2020.

(51) Int. Cl. B22F 10/64; B33Y 40/20

(52) U.S. Cl. CPC B22F 10/64; B22F 10/22; B33Y 40/20

(57) ABSTRACT

A metal object produced by a three-dimensional (3D) metal object manufacturing apparatus is subjected to a high temperature heat treatment to improve bonding of the object layers, especially in the vertical or Z-axis direction. A supporting structure is formed around the metal object to retain the shape and features of the object during the high temperature heat treatment. The supporting structure is formed in a manner that is sufficient to retain the shape of the metal object during the heat treatment but is easily removed once the heat treatment is finished.

### TECHNICAL FIELD

This disclosure is directed to three-dimensional (3D) object printers that eject melted metal drops to form objects and, more particularly, to the treatment of the metal objects after manufacture.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers. The printer typically operates one or more extruders to form successive layers of the plastic material to construct a three-dimensional printed object with a variety of shapes and structures. After each layer of the three-dimensional printed object is formed, the plastic material is UV cured and hardened to bond the layer to an underlying layer of the three-dimensional printed object. This additive manufacturing method is distinguishable from traditional object-forming techniques, which mostly rely on the removal of material from a work piece by a subtractive process, such as cutting or drilling.

Recently, some 3D object printers have been developed that eject drops of melted metal from one or more ejectors to form 3D objects. These printers have a source of solid metal, such as a roll of wire or pellets, that is fed into a heated receptacle of a vessel in the printer where the solid metal is melted and the melted metal fills the receptacle. The receptacle is made of non-conductive material around which an electrical wire is wrapped to form a coil. An electrical current is passed through the coil to produce an electromagnetic field that causes the meniscus of the melted metal at a nozzle of the receptacle to separate from the melted metal within the receptacle and be propelled from the nozzle. A platform opposite the nozzle of the ejector is moved in a X-Y plane parallel to the plane of the platform by a controller operating actuators so the ejected metal drops form metal layers of an object on the platform and another actuator is operated by the controller to alter the position of the ejector or platform in the vertical or Z direction to maintain a constant distance between the ejector and an uppermost layer of the metal object being formed. One type of metal drop ejecting printer that uses magnetohydrodynamic to propel melted metal drops is known as a magnetohydrodynamic (MHD) printer.

In some situations, the mechanical strength of the metal object features formed with MHD printers can be sub-optimal. For example, objects formed with some metals can have layers that weakly bond to one another in the vertical, sometimes called Z-axis, direction. This problem, for example, occurs more frequently with objects formed with aluminum AL6001 than with aluminum AL4008. Factors that are critical to feature formation and layer bonding during the melted metal drop deposition and solidification process include the solidification time scale, which is on the order of ˜3 ms, melted metal drop mass, which is approximately 0.00015 g, melted metal drop temperature, which is in the range of about 750° C. to about 900° C., and the temperature of the last layer printed, which is in a range of about 450° C. to about 550° C. or at least 50° C. below the solidus temperature of the alloy. The solidus temperature of an alloy is the highest temperature at which the alloy remains in the solid phase.

During the melted metal drop deposition and solidification process, the melted metal drops impact the surface of the object and spread, wetting the object surface. These impacts can partially remelt the object beneath its surface to bond the previously ejected drop with the currently ejected drop; however, the thermal mass of the melted metal drop is small compared to the thermal mass of the object and the quenching rate is fast as noted above. These conditions make it highly unlikely that the layers bond together as strongly as expected. Additionally, an oxidation layer can form on the part surface before the impact of the melted metal drop. This oxide layer can hinder the spreading, wetting, and bonding of the ejected melted metal drops with the object. Raising the temperatures of the object, the platform on which the object rests, or the temperature within the build environment of the printer in which the object is formed can improve the bonding between the layers. One or more of these temperature increases, however, can slow the solidification process and cause geometry problems with object features, especially at overhang structures. Finding a way to improve object layer bonding in the Z-axis or vertical direction over currently known methods would be beneficial.

### SUMMARY

A new method of heat treating 3D metal objects made with a 3D metal object printer improves object layer bonding in the Z-axis or vertical direction. The new method includes removing the metal object from the melted metal drop ejecting apparatus, forming a supporting structure about the metal object, heating the metal object to a temperature greater than a solidus temperature of a metal ejected by the melted metal drop ejecting apparatus to produce the metal object, and removing the metal object from the supporting structure.

### BRIEF DESCRIPTION OF THE DRAWINGS

The foregoing aspects and other features of a method for heat treating metal objects formed with a 3D metal object printer to improve object layer bonding in the Z-axis or vertical direction are explained in the following description, taken in connection with the accompanying drawings.

FIG. 1 is a flow diagram for a new method of high temperature heat treatment of metal objects formed with a 3D metal object printer.

FIG. 2A is a flow diagram of a method for forming the supporting structure in the process of FIG. 1 with granular material.

FIG. 2B is a flow diagram of an alternative method for forming the supporting structure in the process of FIG. 1 with a suspension.

FIG. 2C is a flow diagram of another alternative method for forming the supporting structure in the process of FIG. 1 with a solution.

FIG. 2D is a flow diagram of another alternative method for forming the supporting structure in the process of FIG. 1 with a solution.

FIG. 3 is a block diagram of a system for monitoring the temperature of the supporting structure, the container, or the metal object during the process of FIG. 1.

FIG. 4 is a schematic diagram of a prior art 3D metal object printer.

### DETAILED DESCRIPTION

For a general understanding of the environment for the 3D metal object printer and its operation as disclosed herein as well as the details for the printer and its operation, reference is made to the drawings. In the drawings, like reference numerals designate like elements.

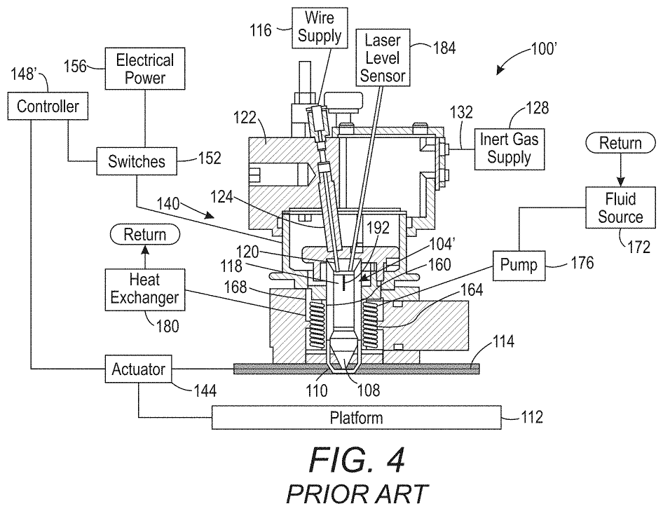

FIG. 4 illustrates an embodiment of a previously known 3D metal object printer 100 used to form metal objects with ejected drops of a melted bulk metal. In the printer of FIG. 4, drops of melted bulk metal are ejected from a receptacle of a removable vessel 104 having a single nozzle 108 and drops from the nozzle form swaths for layers of an object on a platform 112. As used in this document, the term “removable vessel” means a hollow container having a receptacle configured to hold a liquid or solid substance and the container as a whole is configured for installation and removal in a 3D metal object printer. As used in this document, the term “bulk metal” means conductive metal available in aggregate form, such as wire of a commonly available gauge or pellets of macro-sized proportions. A source of bulk metal 116, such as metal wire 120, is fed into a wire guide 124 that extends through the upper housing 122 in the ejector head 140 and melted in the receptacle of the removable vessel 104 to provide melted metal for ejection from the nozzle 108 through an orifice 110 in a baseplate 114 of the ejector head 140. As used in this document, the term “nozzle” means an orifice in a removable vessel configured for the expulsion of melted metal drops from the receptacle within the removable vessel. As used in this document, the term “ejector head” means the housing and components of a 3D metal object printer that melt, eject, and regulate the ejection of melted metal drops for the production of metal objects.

In the 3D metal object printer of FIG. 4, a melted metal level sensor 184 includes a light source and a reflective sensor. In one embodiment, the light source is a laser and in some embodiments a blue laser. The reflection of the laser off the melted metal level is detected by the reflective sensor, which generates a signal indicative of the distance to the melted metal level. The controller receives this signal and determines the level of the volume of melted metal in the removable vessel 104 so it can be maintained at the upper level 118 in the receptacle of the removable vessel. The removable vessel 104 slides into the heater 160 so the inside diameter of the heater contacts the removable vessel and can heat solid metal within the receptacle of the removable vessel to a temperature sufficient to melt the solid metal. As used in this document, the term “solid metal” means a metal as defined by the periodic chart of elements or alloys formed with these metals in solid rather than liquid or gaseous form. The heater is separated from the removable vessel to form a volume between the heater and the removable vessel 104. An inert gas supply 128 provides a pressure regulated source of an inert gas, such as argon, to the ejector head through a gas supply tube 132. The gas flows through the volume between the heater and the removable vessel and exits the ejector head around the nozzle 108 and the orifice 110 in the baseplate 114. This flow of inert gas proximate to the nozzle insulates the ejected drops of melted metal from the ambient air at the baseplate 114 to prevent the formation of metal oxide during the flight of the ejected drops.

The ejector head 140 is movably mounted within Z-axis tracks for vertical movement of the ejector head with respect to the platform 112. One or more actuators 144 are operatively connected to the ejector head 140 to move the ejector head along a Z-axis and are operatively connected to the platform 112 to move the platform in an X-Y plane beneath the ejector head 140. The actuators 144 are operated by a controller 148 to maintain an appropriate distance between the orifice 110 in the baseplate 114 of the ejector head 140 and an uppermost surface of an object on the platform 112.

Moving the platform 112 in the X-Y plane as drops of molten metal are ejected toward the platform 112 forms a swath of melted metal drops on the object being formed. Controller 148 also operates actuators 144 to adjust the vertical distance between the ejector head 140 and the most recently formed layer on the substrate to facilitate formation of other structures on the object. While the molten metal 3D object printer 100 is depicted in FIG. 4 as being operated in a vertical orientation, other alternative orientations can be employed. Also, while the embodiment shown in FIG. 4 has a platform that moves in an X-Y plane and the ejector head moves along the Z axis, other arrangements are possible. For example, the actuators 144 can be configured to move the ejector head 140 in the X-Y plane and along the Z axis or they can be configured to move the platform 112 in both the X-Y plane and Z-axis.

A controller 148 operates the switches 152. One switch 152 can be selectively operated by the controller to provide electrical power from source 156 to the heater 160, while another switch 152 can be selectively operated by the controller to provide electrical power from another electrical source 156 to the coil 164 for generation of the electrical field that ejects a drop from the nozzle 108. Because the heater 160 generates a great deal of heat at high temperatures, the coil 164 is positioned within a chamber 168 formed by one (circular) or more walls (rectilinear shapes) of the ejector head 140. As used in this document, the term “chamber” means a volume contained within one or more walls in which a heater, a coil, and a removable vessel of a 3D metal object printer are located. The removable vessel 104 and the heater 160 are located within this chamber. The chamber is fluidically connected to a fluid source 172 through a pump 176 and also fluidically connected to a heat exchanger 180. As used in this document, the term “fluid source” refers to a container of a liquid having properties useful for absorbing heat. The heat exchanger 180 is connected through a return to the fluid source 172. Fluid from the source 172 flows through the chamber to absorb heat from the coil 164 and the fluid carries the absorbed heat through the exchanger 180, where the heat is removed by known methods. The cooled fluid is returned to the fluid source 172 for further use in maintaining the temperature of the coil in an appropriate operational range.

The controller 148 of the 3D metal object printer 100 requires data from external sources to control the printer for metal object manufacture. In general, a three-dimensional model or other digital data model of the object to be formed is stored in a memory operatively connected to the controller 148, the controller can access through a server or the like a remote database in which the digital data model is stored, or a computer-readable medium in which the digital data model is stored can be selectively coupled to the controller 148 for access. This three-dimensional model or other digital data model is processed by a slicer implemented with the controller to generate machine-ready instructions for execution by the controller 148 in a known manner to operate the components of the printer 100 and form the metal object corresponding to the model. The generation of the machine-ready instructions can include the production of intermediate models, such as when a CAD model of the device is converted into an STL data model, or other polygonal mesh or other intermediate representation, which can in turn be processed to generate machine instructions, such as g-code, for fabrication of the device by the printer. As used in this document, the term “machine-ready instructions” means computer language commands that are executed by a computer, microprocessor, or controller to operate components of a 3D metal object additive manufacturing system to form metal objects on the platform 112. The controller 148 executes the machine-ready instructions to control the ejection of the melted metal drops from the nozzle 108, the positioning of the platform 112, as well as maintaining the distance between the orifice 110 and the uppermost layer of the object on the platform 112.

The controller 148 can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During metal object formation, image data for a structure to be produced are sent to the processor or processors for controller 148 from either a scanning system or an online or work station connection for processing and generation of the signals that operate the components of the printer 100 to form an object on the platform 112.

To improve the layer-to-layer bonding in the Z-axis or vertical direction, a post-manufacture treatment method builds a supporting structure around a metal object after it is removed from the printer and then heats the metal object within the supporting structure to a sufficiently high temperature that softens or partially melts the metal object. Making the object malleable within the supporting structure enables the bonding between the previously formed layers of the object to strengthen without suffering object feature deformation.

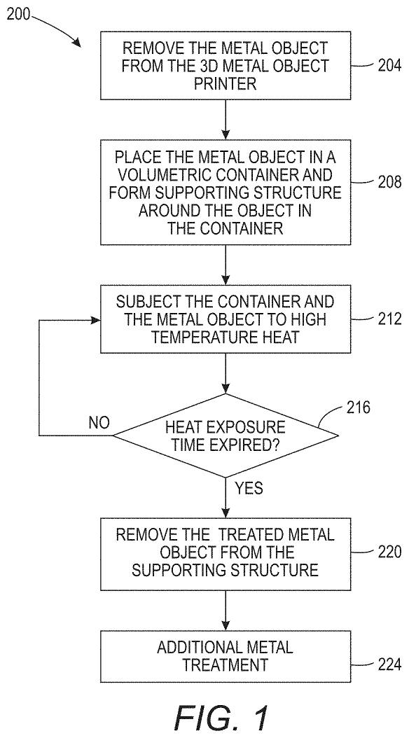

A process for treating a metal object made by the 3D metal object printer 100 is shown in FIG. 1. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 148 noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

FIG. 1 is a flow diagram for a process 200 that treats a metal object made by a 3D metal object printer to improve the bonding between the object layers in the Z-axis or vertical direction. The process begins with removal of a 3D metal object from the build environment of the 3D metal object printer 100 (block 204). The object is placed within a volumetric container and a supporting structure is built around the printed 3D metal object in the container (block 208). As described more fully below, the supporting structure is formed with material that conforms closely to the outline of the object without adhering tightly to the object so it can be readily removed after the heat treatment of the supporting structure and object is completed. The supporting structure and object within the supporting structure are heated to a temperature sufficient to at least soften or even partially melt the metal of the object within the supporting structure (block 212). This temperature is at least slightly above the solidus temperature of the metal forming the object up to about the melting temperature of the metal. This heating continues for a predetermined time adequate for accomplishing the improved bonding between the metal object layers (block 216). The supporting structure is removed from the strengthened metal object (block 220). After the object is removed from the supporting structure, it can be treated with other known heat treatments, such as quenching or the like, that are typically performed at temperatures that are less than the melting or structural softening temperature of the metal object (block 224).

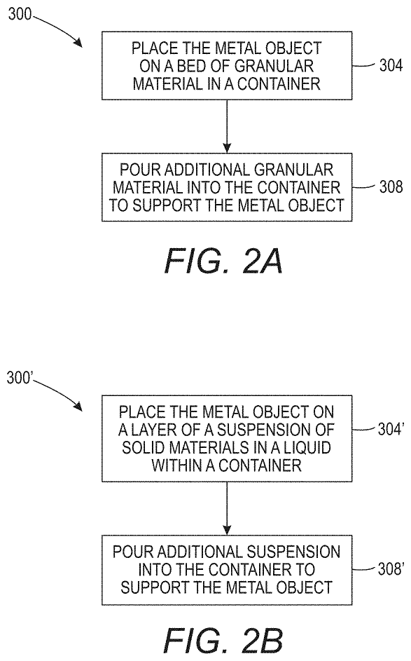

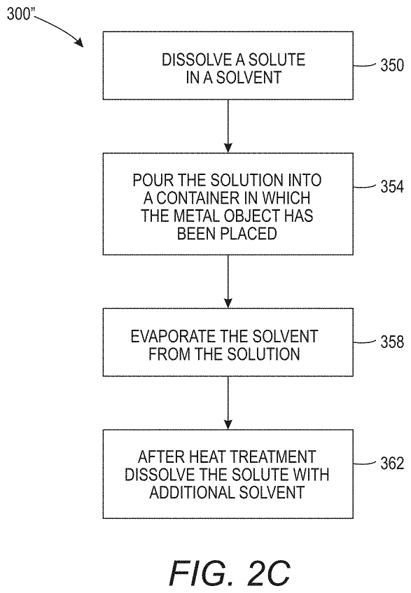

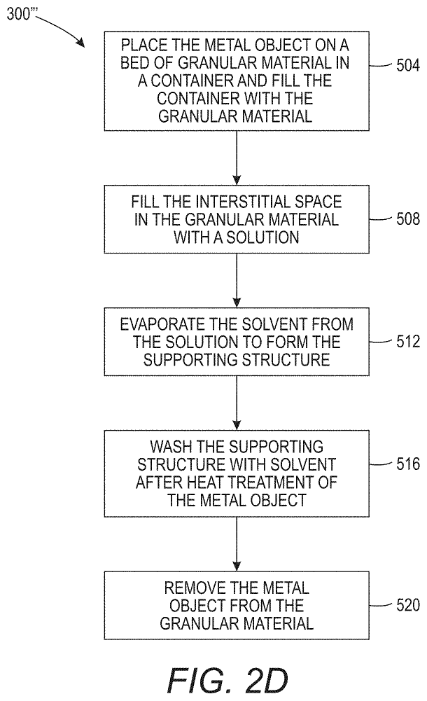

Formation of the supporting structure about the part is now discussed. As noted above, the supporting structure needs to conform to the outline of the metal object without adhering tightly to the metal object. Alternative embodiments of a method for forming the supporting structure in the process 200 (block 208) are now discussed. In one embodiment of the supporting structure formation process 300 shown in FIG. 2A, the metal object is placed in a container on a bed of granular material, such as sand, a chemical salt, high temperature powder, glass beads having a diameter of about 10 μm to about 50 μm, or a combination of these materials (block 304). Additional granular material is poured into the container to a level that at least supports the features of the metal object so they do not deform from gravity when they are heated (block 308). In one embodiment, an amount of granular material sufficient to encase the entire metal object is poured into the container. The granular material can be tamped to pack the material more densely. Alternatively, the container can be shaken or vibrated to pack the material about the object. As used in this document, the term “granular material” refers to a plurality of small, hard particles of a solid material having a size that enables them to be packed around a metal object placed within a container. The container and the supporting structure formed with the granular material filling the container are subjected to the high temperature that improves the bonding of the object layers to one another. After the high temperature heat treatment, the object can be easily removed from the container provided the fusing temperature of the granular material has not been reached.

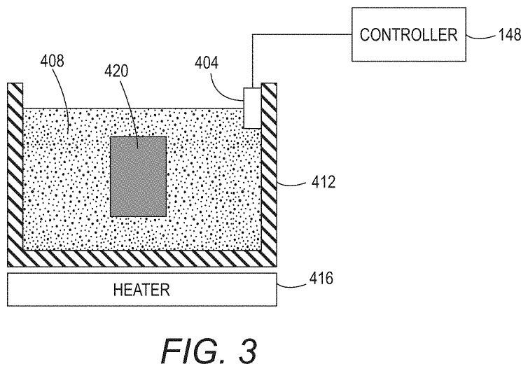

As shown in FIG. 3, a temperature sensor 404 can be placed in the granular material 408 or on the container 412 and connected to the controller 148 so its signal can be monitored by the controller. The controller 148 uses this signal indicative of the granular material temperature or of the container temperature to regulate the operation of the heater 416 to ensure that the fusing temperature of the granular material is not reached during the high temperature heat treatment of the metal object 420.

Another embodiment of the process for forming metal object supporting structure is depicted in the process 300′ shown in FIG. 2B. This process begins by placing the metal object on a layer formed with a suspension of solid materials, such as calcined lime, within a liquid, such as water (block 304′). As used in this document, the term “suspension” means a heterogeneous mixture of a fluid that contains solid particles sufficiently large for sedimentation. An additional volume of the suspension is poured around the object to form a supporting structure that is at least adequate to support the object features or that encases the object (block 308). After the high temperature heat treatment of the metal object within this suspension, the suspension, which has hardened and become brittle, can be easily removed with a mechanical impact force provided the thickness of the suspension has been appropriately controlled with the volume of the container. That is, the walls of the suspension about the metal object are not too thick to resist cracking once the suspension and metal object are removed from the container.

In a variant of this embodiment, clay is pressed against the metal object to form the supporting structure. The embedded object and the clay are subjected to the high temperature heat treatment provided the deformation temperature of the clay is not reached during the process. For example, a metal object made with common aluminum alloys has a melting temperature of about or less than 650° C., while common clays have a deformation temperature of about 1000° C. Thus, the temperature of the clay and object can be monitored by the controller 148 using a temperature sensor embedded in the clay similar to the manner shown in FIG. 3 to ensure the object is heated to a temperature sufficient to improve the layer-to-layer bonding of the object without approaching the deformation temperature of the clay.

Another embodiment of the method for constructing the supporting structure around the metal object is shown in FIG. 2C. In this process 300″, a liquid solution is made by dissolving a solute in a solvent (block 350) and the solution is poured into a container in which the metal object has been placed (block 354). The solution is then heated to its evaporation temperature so the liquid is removed from the solution to form the supporting structure (block 358). The solute material that remains after evaporation is complete forms a supporting structure and the solute is selected to have a melting temperature above the melting or softening temperature of the metal object. After the heat treatment is complete, the supporting structure is removed by dissolving the supporting structure (block 362).

In one example of the process shown in FIG. 2C, a salt solution can be formed and poured into the container about the metal object. After the water in the solution is evaporated, the crystal salt forms the supporting structure and the high temperature heat treatment of the supporting structure and metal object performed. The melting temperature of sodium chloride is approximately 800° C. so it does not melt before the softening or melting temperature of an aluminum object is reached. After the heat treatment of the object, the salt supporting structure can be dissolved with water. One way in which this type of supporting structure can be formed is to fill the space surrounding the metal object in a container with salt grains that are tightly packed. Steam is directed into the packed salt to add water to the salt and form the solution. The moist packed salt is permitted to dry so the salt powder sticks together to form a powder cake that is sufficiently strong to maintain the shape of the supporting structure about the object during the high temperature heat process. Removal of the supporting structure can be done by washing the supporting structure with water.

Another embodiment of the method for constructing the supporting structure around the metal object is shown in FIG. 2D. In this process 300′″, the object is placed on a bed of granular material in a container and granular material is poured into the container to embed the object in the granular material (block 504). Fill the interstitial space in the granular material with a liquid solution (block 508). The container is then heated to a temperature sufficient to evaporate the liquid from the solution to form the supporting structure (block 512). The solute now functions as a bonding agent to strengthen the granular material support structure. This embodiment uses much less solution and solute than the embodiment depicted in FIG. 2C so less drying time is required to construct the support structure. Removal of this strengthened composite support structure is accomplished by washing the structure with solvent to weaken its structural strength (block 516) and then removing the granular material from around the part (block 520).

Various implementations of the embodiment shown in FIG. 2D are possible. In one, the solution is a salt solution that is used in combination with sand. Another variant of this implementation mixes the granular material, such as sand, with the solution and the resulting mixture is poured into the container to form the supporting structure. Another variant of this implementation, mixes a small amount of the solute with the granular material before the mixture is packed around the part to form a granular support structure. Solvent is applied to the granular support structure in liquid or vapor form to dissolve the solute in the structure. After the solvent is evaporated, a strong composite supporting structure is produced. The small amount of the solute mixed with the granular material can be, for example, five percent of the mass of the granular material.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A method for high temperature heat treatment of a metal object produced with a melted metal drop ejecting apparatus comprising:
removing the metal object from the melted metal drop ejecting apparatus;
forming a supporting structure about the metal object;
heating the metal object to a temperature greater than a solidus temperature of a metal ejected by the melted metal drop ejecting apparatus to produce the metal object; and
removing the metal object from the supporting structure.

2. The method of claim 1 further comprising:
maintaining the temperature of the metal object above the solidus temperature for a predetermined period of time sufficient to bond layers of the metal object in a vertical direction.

3. The method of claim 2, the supporting structure formation further comprising:
filling a container with a granular material after the metal object has been placed on a layer of the granular material in the container.

4. The method of claim 3 wherein the granular material is essentially comprised of sand.

5. The method of claim 3 wherein the granular material is essentially comprised of glass beads having a diameter in a range of about 10 μm to about 50 μm.

6. The method of claim 3 wherein the granular material has a fusing temperature greater than the melting temperature of the metal used to produce the metal object.

7. The method of claim 2, the supporting structure formation further comprising:
filling a container with a suspension of a solid material after the metal object has been placed on a layer of the suspension of the solid material in the container.

8. The method of claim 7 wherein the suspension is a mixture of water and calcined lime.

9. The method of claim 2, the supporting structure formation further comprising:
forming a solution by dissolving a solute in a solvent;
pouring the solution into a container in which the metal object has been placed;
evaporating the solvent from the solution in the container to encase the metal object in the solute.

10. The method of claim 9 further comprising:
dissolving the solute to remove the metal object from the solute.

11. The method of claim 9 further comprising:
packing grains of a salt about the metal object that has been placed on a layer of salt grains in the container;
directing steam through the packed grains of the salt to form a salt solution about the metal object; and
drying the salt solution to form a powder cake about the metal object.

12. The method of claim 11 further comprising:
washing the powder cake with liquid water to remove the powder cake from the metal object.

13. The method of claim 2 further comprising:
generating a signal indicative of a temperature of the temperature of the metal object; and
using the signal to operate a heater that heats the metal object and the supporting structure.

14. The method of claim 3 further comprising:
filling the container with the granular material to a level sufficient to prevent gravity from deforming features extending from the object.

15. The method of claim 14 further comprising:
tamping the granular material to increase the density of the granular material about the metal object.

16. The method of claim 14 further comprising:
filling the container with the granular material to a level that encases the metal object.

17. The method of claim 16 further comprising:
tamping the granular material to increase the density of the granular material about the metal object.

18. The method of claim 17, the tamping of the granular material further comprising:
vibrating the container.

19. The method of claim 2, the supporting structure formation further comprising:
pouring a granular material into a container in which the metal object has been placed; and
evaporating a solvent from a solution in the granular material to bind the granular material together.

20. The method of claim 19 further comprising:
mixing the solution with the granular material before pouring the granular material into the container.

21. The method of claim 19 further comprising:
mixing a solute with the granular material before pouring the granular material into the container; and
applying a solvent to the mixture of solute and granular material to form the solution with the granular material before evaporating the solvent.

22. The method of claim 21, the application of the solvent further comprising:
directing the solvent in one of a vapor form or liquid form through the granular material to form the solution with the granular material.

23. The method of claim 19 further comprising:
washing the granular material and the solute with the solvent to release the metal object from the granular material and the solute.
